(19) United States
(12) Patent Application Publication
(10) Pub. No.: US 2004/0022490 A1
(43) Pub. Date: Feb. 5, 2004

(54) Loss compensated wavelength division multiplexing filter module

(76) Inventors: James K. Eu, Fremont, CA (US); Tong-Ning Li, Milpitas, CA (US); C. Jacob Sun, Saratoga, CA (US)

Correspondence Address: Finnegan, Henderson, Farabow,, Garrett & Dunner, L.L.P., 700 Hansen Way, Palo Alto, CA, 94304, US

(21) Appl. No.: 10/623,105

(22) Filed: Jul. 18, 2003

Related U.S. Application Data
(63) Continuation of application No. 09/802,341, filed on Mar. 9, 2001, now abandoned.

(51) Int. Cl. G02B 6/34; G02B 6/12

(52) U.S. Cl. 385/37; 359/344; 385/14

(57) ABSTRACT

A filter module that includes a filter, such as an AWG filter, and a semiconductor optical amplifier (SOA) is described. Additionally, a method of multiplexing and/or demultiplexing optical signals using the DWDM filter module is described. The filter and SOA can be integrated together either through compact packaging (with fiber and connectors), or through on-chip integration. The SOA can fully compensate for the insertion loss due to, for example, an AWG filter or plurality of AWG filters. Additionally, the polarization dependent loss of the composite module can be reduced by adjusting the polarization dependent gain of the SOA to compensate for the polarization dependent loss of the AWG filter.

### BACKGROUND

1. Field of the Invention

The present invention relates to multiplexing and demultiplexing of wavelength division multiplexed optical signals and, in particular, to multiplexer and demultiplexer systems having on optical amplifier to substantially lower optical loss.

2. Discussion of Related Art

As a result of the explosive growth of the Internet, many telecommunications companies are finding it difficult to provide sufficient network capacity to deal with the increased demand. Dense wavelength division multiplexing (DWDM) technology is a practical and economical solution to this problem. It enables multiple wavelength transmission through existing fiber plant, thereby increasing network capacity. In some cases optical signals on 16 to 80 wavelengths can be transmitted through a single fiber, increasing the capacity of the network by a factor of from 16 to 80 times.

In wavelength division multiplexing, multiple data signals are transmitted over an optical beam that includes a plurality of light beams, each one of the plurality of light beams having light of a specified wavelength. A single fiber, therefore, can carry the optical beam with individual data signals on each of the plurality of light beams. In other words, data signals can be transmitted on different wavelengths of light through the optical fiber. Wavelength-division multiplexing can be combined with time-division multiplexing as well as other data transmission schemes (e.g., packet transmission) in order to transmit large volumes of data over the network at very high data transmission rates.

Most nodes on the network have the ability to receive signals directed to that node. When wavelength-division multiplexing is used, nodes typically receive signals from light of a subset of the available wavelengths propagating on the optical fiber. Nodes on the network, therefore, need the ability to “drop” one or more of the plurality of light beams so that data signals carried on those dropped light beams can be processed by node opto-electronics.

Additionally, at least one of the nodes on the network has the ability to couple signals onto the available light beams of individual wavelengths propagating on the optical fiber. These nodes, then, need to be able to “add” light of one or more of the different wavelengths to the corresponding one or more of the plurality of light beams.

Light beams of individual wavelengths are “dropped” or “added” through demultiplexing and multiplexing systems, respectively. Typically, the multiplexer or demultiplexer component includes narrow wavelength spaced filter devices in order to separate individual wavelength components of the transparent beam and thereby separate out the light beams of individual wavelengths. As such, narrow wavelength spaced filter devices are a core component of most WDM (or DWDM) systems.

However, narrow wavelength spaced filter devices suffer from insertion loss, cross-talk, polarization dependent loss (PDL), and temperature instability. There is optical signal loss each time light passes through a filter device. A typical 16-40 channel arrayed waveguide grating (AWG) filter, for example, causes an insertion loss of 5 to 8 dB in addition to a polarization dependent loss of between 0.2 and 0.5 dB. Since each DWDM system typically incorporates several such devices, the optical signal degrades significantly upon transmission through the various multiplexer/demultiplexer components.

Current solutions to the problem of optical signal loss in a multiplexer/demultiplexer system are impractical for many applications, especially cost sensitive Metro network applications. For example, complicated and expensive erbium doped fiber amplifiers (EDFA) are typically used to compensate for the signal loss. Additionally, more sensitive, high end detectors may be needed to detect the signal, which again significantly increases the system cost.

Therefore, there is a need for optical networking components, such as, for example, multiplexer or demultiplexer systems, which have little or no optical loss for transmission of optical signals through the individual components.

### SUMMARY

In accordance with the present invention, a filter module includes a narrow band optical filter coupled to an optical amplifier. The filter and optical amplifier can, in some embodiments, be integrated together either through compact packaging (with fiber and connectors), or through on-chip integration. A filter module according to the present invention can be utilized for multiplexing and/or demultiplexing of optical signals, for example the optical signals at differing wavelengths as in a WDM or DWDM optical system. Embodiments of the current invention provides a low-cost solution to the problem of optical signal loss in DWDM optical systems.

In some embodiments, the filter can include an arrayed wave guide (AWG) filter. In some embodiments, the filter can include thin film filters, Bragg gratings, bulk grating devices, or other filters which is capable of separating an incoming light beam into separate wavelengths. For use with a WDM or DWDM optical system, the filter is capable of separating a light beam into components consistent with a preselected wavelength grid.

Typically, however, filters suffer from insertion loss and may further suffer from polarization dependent loss (PDL). The amplifier substantially compensates for these losses. In some embodiments, the amplifier is a semiconductor optical amplifier (SOA)

This invention can be more fully understood in light of the following detailed description taken together with the accompanying figures.

### BRIEF DESCRIPTION OF THE FIGURES

FIG. 1 shows a block diagram of a multiplexer system according to the present invention.

FIG. 2 shows a block diagram of a demultiplexer system according to the present invention.

FIG. 3 shows block diagram of an on-chip integrated multiplexer according to the present invention.

FIG. 4 shows a block diagram of an on-chip integrated demultiplexer according to the present invention.

FIGS. 5a, 5b, and 5c show block diagrams of a flip-chip bonding process used to bond an SOA chip to an AWG device in embodiments according to the present invention.

FIG. 6 shows a block diagram of a multiplexer/demultiplexer system according to the present invention.

FIG. 7 shows a block diagram of an arrayed waveguide grating.

FIG. 8 shows a block diagram of a semiconductor optical amplifier.

### DETAILED DESCRIPTION

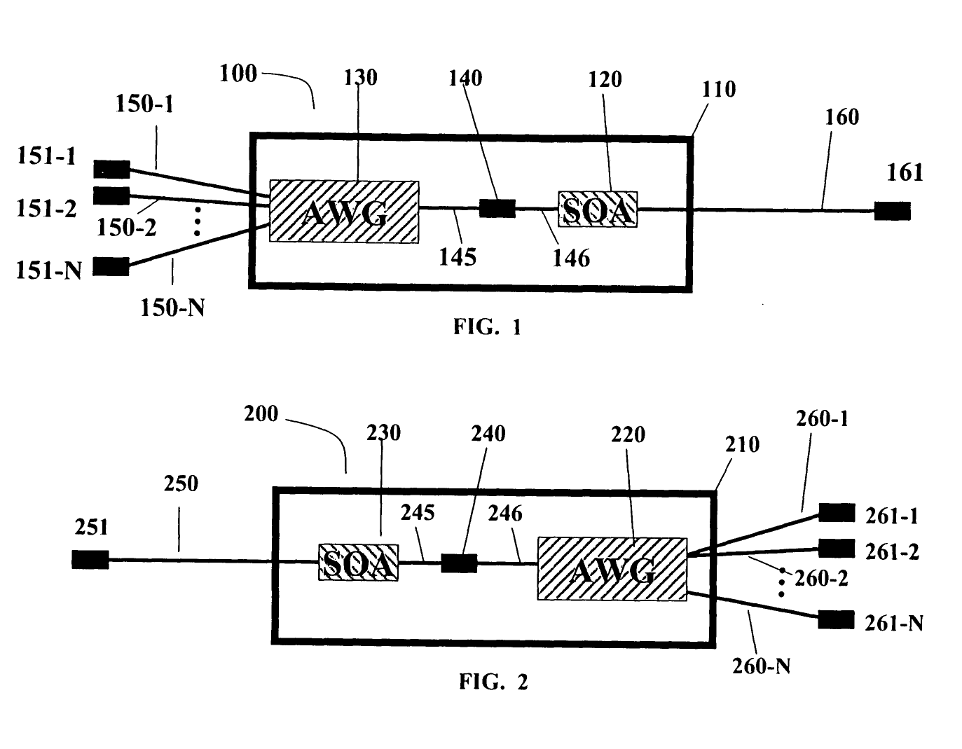

FIG. 1 shows a block diagram of a multiplexer 100 according to the present invention. Multiplexer 100 includes a filter device 130, which can be an AWG filter, coupled to an optical amplifier 120, which can be a semiconductor optical amplifier (SOA), by optical fibers 145 and 146 coupled by connector 140. In some embodiments, multiplexer 100 is packaged in a housing unit 110.

Input fibers 150-1 through 150-N, collectively referred to as input fibers 150, each can transport optical signals having different wavelengths. Light can be coupled into input fibers 150-1 through 150-N through optical connectors 151-1 through 151-N, respectively. The optical signals transported by each of input fibers 150-1 through 150-N are combined in filter device 130, producing a single multiplexed signal which is coupled into optical fiber 145. The multiplexed signal is transmitted through optical fibers 145 and 146, which are coupled by connector 140, to optical amplifier 120. Optical amplifier 120 substantially compensates for the optical loss due to filter 130. The multiplexed signal is then coupled into output fiber 160 which can be coupled through connector 161 to an external optical fiber (not shown).

In general, there can be any number of input fibers 150-1 through 150-N carrying optical signals of wavelengths corresponding to any wavelength grid. In general, the wavelength grid utilized in a WDM or DWDM system is preset, for example, by the International Telecommunications Union (ITU) standards. Wavelength separations on an example of such a grid are wavelengths separated by about 0.8 nm and centered around 1550 nm.

Filter device 130 is capable of separating an input light beam into its separate wavelength constituents corresponding to wavelengths on the wavelength grid of a WDM or DWDM system. In multiplexer 100 as shown in FIG. 1, filter device 130 functions as a coupler, receiving light beams of wavelengths corresponding to wavelengths on the grid from input fibers 150-1 through 150-N and combining them into a single multiplexed light beam coupled to fiber 145. Filter device 130 can be an AWG filter, an array of thin film filters, a Bragg grating filter, a bulk grating device (e.g., a holographic grating), or any other filter capable of separating a light beam into components corresponding to the wavelength grid of the WDM or DWDM system (and conversely of combining light beams of the different wavelengths into a single light beam).

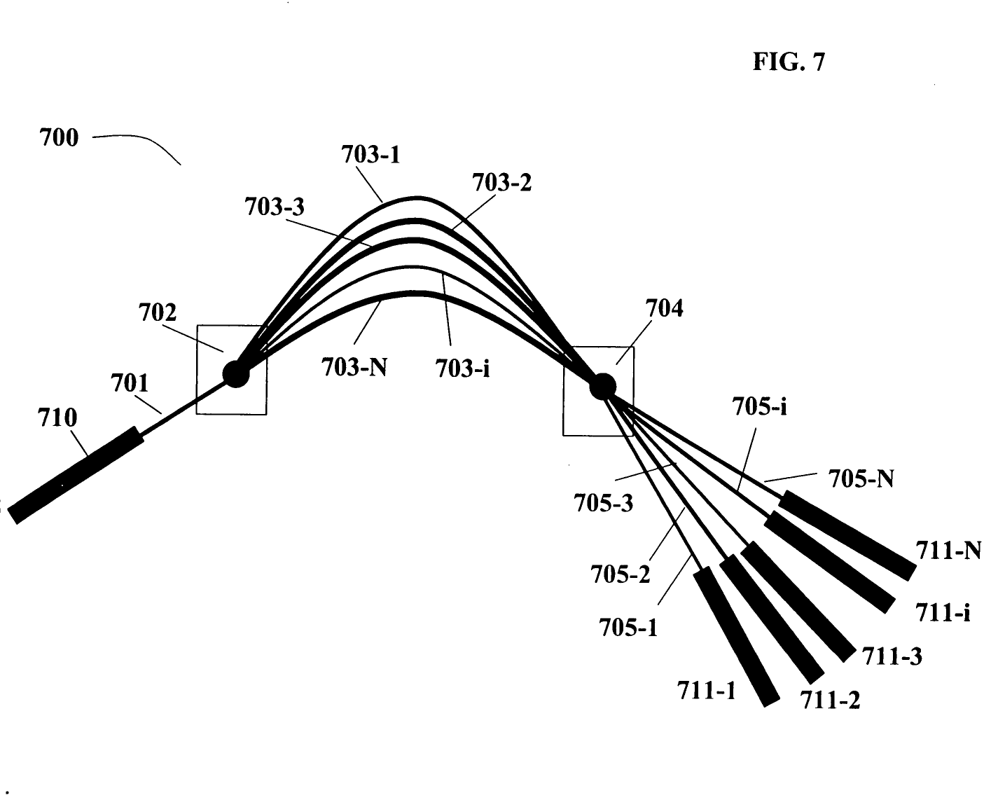

FIG. 7 shows an example of an AWG filter 700 which may be utilized as filter 130 in FIG. 1. AWG filter 700 includes a waveguide 701 coupled to a star coupler 702 Waveguide 701 can be coupled to an optical fiber 710. Star coupler 702 couples light between waveguide 701 and grating waveguides 703-1 through 703-N, where N is an integer and waveguide 703-i refers to an arbitrary one of waveguides 703-1 through 703-N. The optical paths through each of waveguides 703-1 through 703-N is different so that individual wavelength components are separated by interference effects in star coupler 704. Star coupler 704 couples light between waveguides 703-1 through 703-N and waveguides 705-1 through 705-N. Each of waveguides 705-1 through 705-N, then transmits light of one of the component wavelengths. Waveguides 705-1 through 705-N can, then, be coupled into optical fibers 711-1 through 711-N, respectively. AWG filter 700, then, includes two star couplers coupled by phase-shifting arrayed waveguides 703-1 through 703-N. In operation, light entering waveguide 701 is separated into its separate wavelength components and coupled into waveguides 705-1 through 705-N by grating waveguides 703-1 through 703-N. Additionally, light entering waveguides 705-1 through 705-N is combined and coupled to waveguide 701.

Amplifier 120 can be any light amplification device, including a semiconductor optical amplifier (SOA). A semiconductor optical amplifier typically includes a substrate and an active region. In some embodiments of an SOA, the active region is InGaAsP based technology. In typical operation, an SOA is coupled to an input optical fiber 146 and an output optical fiber 160. A voltage is applied across the active region of the SOA so that, when an optical signal is input from input optical fiber 146, an amplified optical signal is output at output optical fiber 160. Typically, the gain of the SOA is a function of the voltage applied to the SOA.

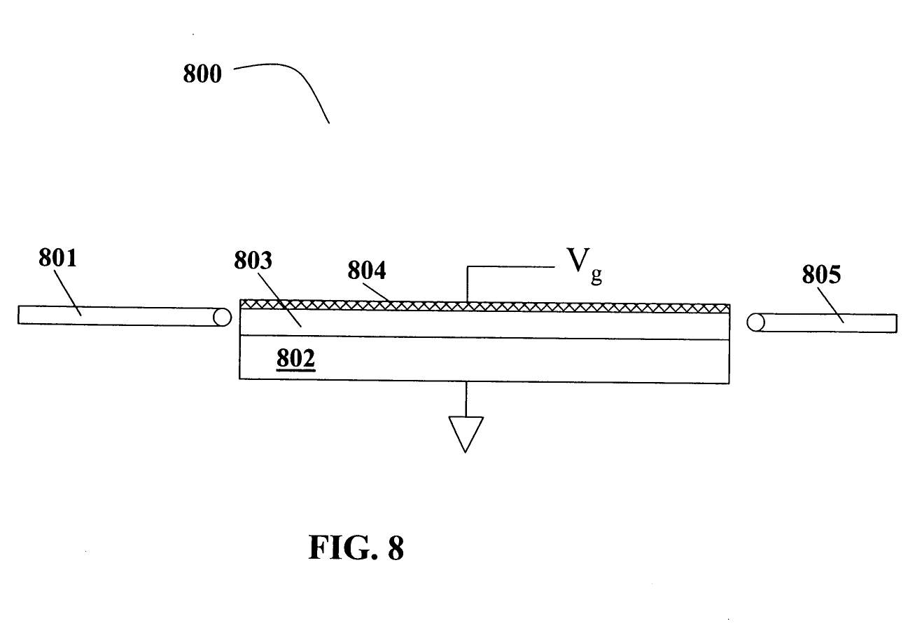

FIG. 8 shows an embodiment of a semiconductor optical amplifier (SOA) 800 which can be utilized in embodiments of the present invention. SOA 800 includes a substrate 802 on which an optically active layer 803 is deposited. Optically active layer 803 can be, for example, a InGaAsP based material. Active layer 803 can be coated with a conductive material 804, for example a metal, which is held at a voltage V_{g} relative to substrate 802. Light is coupled into active layer 803 from optical fiber or optical waveguide 801 and coupled out of active layer 803 into optical fiber or optical waveguide 805. In operation, voltage V_{g} excites electronic states in active layer 803 so that when photons enter active layer 803 from optical fiber or optical waveguide 801 the excited electronic states decay and emit further photons of similar wavelength as the original photon. Therefore, the optical gain of active layer 803 is determined by the number of excited states that can be induced to emit photons.

Amplifier 120 of FIG. 1 compensates for the losses, both insertion losses and polarization dependent loses (PDLs), suffered in filter 130 and in coupling to filter 130. An AWG filter, for example, can have a 5 to 8 dB insertion loss and typically includes a polarization dependent loss (PDL) of between 0.2 to 0.5 dB. The optical amplifier compensates, at least partially, for the losses suffered in the filter.

If, for example, amplifier 120 is an SOA, a gain of up to 12 to 20 dB can be realized and therefore the insertion loss due to filter 130 can be compensated. Additionally, an SOA 120 can reduce or eliminate the polarization dependent loss (PDL) due to, for example, an AWG filter 130. An SOA has a similar amount of polarization dependent gain (PDG) as the polarization dependent loss (PDL) of an AWG filter. The PDL of the composite module can be reduced by adjusting the PDL of the AWG to match the PDG of the SOA.

For example, an SOA normally has higher gain in the TE mode. The PDL of the AWG may be adjusted so that the TE mode loss is higher than the TM mode loss by making the cross section of an input waveguide (e.g., waveguide 701 of FIG. 7) asymmetrical or by adjusting the refractive index difference between the core and cladding of the waveguides in the AWG (see, for example, AWG 700 of FIG. 7). Coupling an AWG filter with higher TE mode loss with an SOA with higher gain in the TE mode will reduce the total PDL of the composite filter module. Therefore, embodiments of multiplexer 100 can be adjusted so that they are substantially lossless, with amplifier 120 nearly completely compensating for the losses suffered in filter 130.

FIG. 2 shows a block diagram of a demultiplexer 200 according to the present invention. Demultiplexer 200 includes an amplifier 230 coupled to a filter device 220. Light is coupled into amplifier 230 from optical fiber 250. Optical fiber 250 can be coupled to outside fibers (not shown) through an optical connector 251. Amplifier 230 can be an SOA amplifier such as SOA 800 as shown in FIG. 8. In general, amplifier 230 can be any amplifier capable of compensating for the losses in demultiplexer 200. Filter device 220 can be an AWG filter such as filter 700 as shown in FIG. 7 or may be another narrow band filter device (e.g., thin-film filters, Bragg gratings, and bulk gratings) capable of separating light from fiber 250 into its individual wavelength components. Amplifier 230 and filter 220 are coupled by optical fibers 245 and 246 which can be coupled together by connector 240. Optical fiber 245 and connector 240 can be packaged in housing unit 210.

A multiplexed signal is coupled into amplifier 230 from input optical fiber 250. The light from amplifier 230 is coupled into filter 220. Amplifier 230, which can be an SOA, amplifies by an amount large enough to substantially overcome the losses experienced in filter 220. Filter 220 separates the optical signal from optical amplifier 230 into separate wavelength components, which typically fall on a predefined wavelength grid. The separate wavelength signals are then transmitted through output fibers 260-1 through 260-N to connectors 261-1 through 261-N. Separate external optical fibers (not shown) can be optically coupled to optical fibers 260-1 through 260-N through connectors 261-1 through 261-N to receive the demultiplexed separate wavelength signals from filter 220.

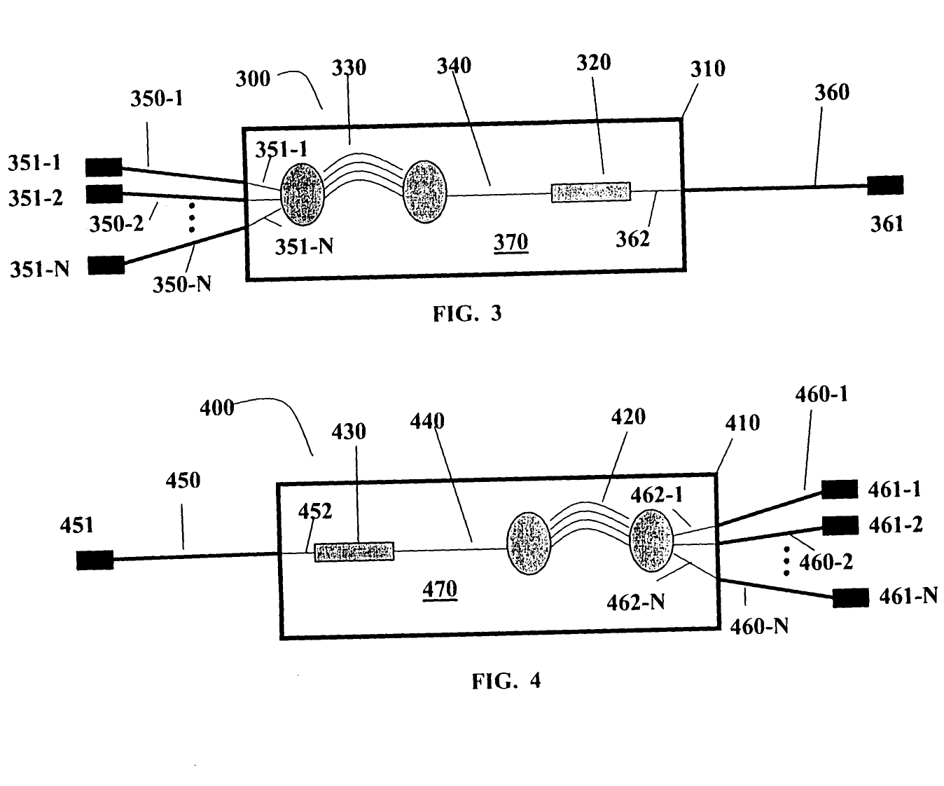

FIG. 3 shows an embodiment of a multiplexer 300 formed on a single integrated chip. Filter 330, which can be an AWG filter, and connecting waveguide 340 can be fabricated on a common substrate; for example, silicon or silica glass. Waveguide 340 and an AWG filter can be fabricated of any waveguide material, for example silica, silicon, silicon oxynitride, or polymer materials. An amplifier 320, which in some embodiments is an SOA chip such as SOA 800 shown in FIG. 8, can be positioned and bonded into an etched well on the same substrate and aligned with connecting waveguides 340 and 361. Input fibers 350-1 through 350-N carry optical signals of different wavelengths, corresponding to the predefined channels of the optical system. Optical signals are coupled into input fibers 350-1 through 350-N from external fibers (not shown) through connectors 351-1 through 351-N. The optical signals from input fibers 350-1 through 350-N are coupled into on-chip waveguides 352-1 through 352-N, respectively.

A filter device 330 receives the signals from each of optical waveguides 352-1 through 352-N and combines them to produce a single multiplexed signal. In FIG. 3, filter 330 is shown as an AWG filter such as AWG 700 shown in FIG. 7. The single multiplexed signal is coupled into amplifier 320 through waveguide 340. Amplifier 320 amplifies the single multiplexed signals in order to substantially compensating for optical losses due to filter 330 and other coupling losses in the optical system. Amplifier 320 can be an SOA such as SOA 800 shown in FIG. 8. The amplified multiplexed signal is then coupled into optical waveguide 362 and then into optical fiber 360. The amplified multiplexed signal is transmitted through output fiber 360 and can be coupled to an external optical fiber (not shown) through connector 361.

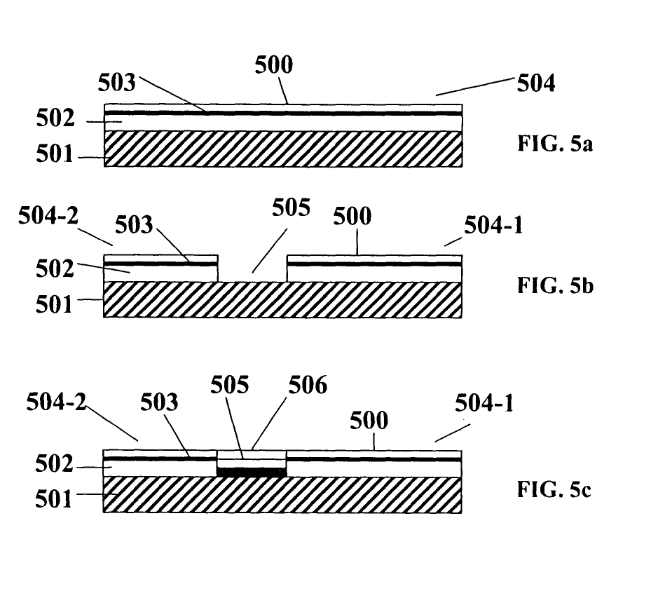

FIG. 4 shows an embodiment of a demultiplexer 400 formed on a single integrated chip. Amplifier 430 is coupled to receive light from optical waveguide 452 which is coupled to receive light from optical fiber 450. Optical fiber 450 can be coupled to an external optical fiber through connector 451. Amplifier 430 amplifies the input signal received from optical fiber 450 in order to substantially overcome any optical losses in demultiplexer 400. The amplified optical signal is coupled into waveguide 440 and then into filter 420. Filter 420 in demultiplexer 400 can be an AWG filter such as AWG 700 shown in FIG. 7. Filter 420 separates the amplified optical signal into its single wavelength components which correspond to the optical grid defined for the optical system of which demulitplexer 400 is a part. Light of each of the separate wavelengths is coupled into waveguides 462-1 through 462-N and then into optical fibers 460-1 through 460-N. Each of optical fibers 460-1 through 460-N then carries an optical signal of one of the wavelengths corresponding to the wavelength grid of the optical system. The optical signals on each of optical fibers 460-1 through 460-N can be coupled to external optical fibers (not shown) through connectors 461-1 through 461-N, respectively.

Filter 420 and connecting waveguides 440, 452, and 462-1 through 462-N can be fabricated on a common substrate; for example, silicon or silica glass. Amplifier 430, which can be SOA 800 as shown in FIG. 8, is positioned and bonded into an etched well on the same substrate between waveguides 452 and 440. Input fiber 450 transmits a multiplexed signal which is then amplified by amplifier 430 and separated by filter 420, which demultiplexes the multiplexed signal. The demultiplexed signals, each now a different wavelength, are then transmitted through output fibers 460-1 through 460-N to optical connectors 461-1 through 461-N.

FIGS. 5a, 5b and 5c illustrate the process of fabricating a multiplexer or demultiplexer such as multiplexer 300 shown in FIG. 3 or demultiplexer 400 shown in FIG. 4. FIG. 5a shows a substrate 501, which can be silicon or silica glass. An optical waveguide 504, which includes a core layer 503, a lower cladding 502, and a top cladding 500, is formed on substrate 501. Optical waveguide 504 can be formed from any waveguide material, including silica, silicon, silicon oxynitride, and polymer materials. Optical waveguide 504 can be formed by a chemical vapor deposition (CVD) process or by any other deposition method. Optical waveguide 504 carries the multiplexed signal. For example, in multiplexer 300 of FIG. 300, optical waveguide 504 corresponds to waveguides 340 and 362. In demultiplexer 400 of FIG. 4, optical waveguide 504 corresponds to waveguides 452 and 440. In other words, waveguides 340 and 362 on integrated circuit chip 370 of FIG. 3 and optical waveguides 440 and 452 of integrated circuit chip 470 of FIG. 4 are deposited as a single waveguide corresponding to optical waveguide 504 of FIG. 5. Waveguides for the formation of filters 330 of FIG. 3 and 420 of FIG. 4 can be deposited with waveguide 504 and can be coupled to waveguide 504 to form either multiplexer 300 of FIG. 3 or demultiplexer 400 of FIG. 4.

FIG. 5b illustrates formation of a well 505 by etching through waveguide 504 and layers 502 and 503. Waveguide 504, then, is split into two waveguides, waveguides 504-1 and 504-2. Any one of a number of well known etching processes can be utilized to form well 505. Amplifier 506, which can be an SOA such as SOA 800 shown in FIG. 8, can then be inserted and bonded into well 505 in order that it is aligned with waveguide 504. Light is then coupled into and out of amplifier 506 through waveguides 504-1 and 504-2.

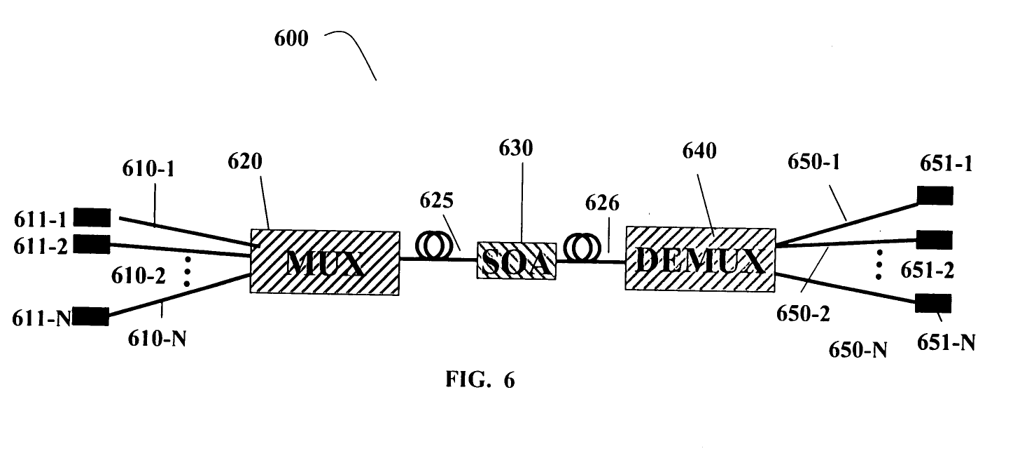

FIG. 6 shows a multiplexer/demultiplexer module 600 according to the present invention. Multiplexer/demultiplexer module 600 includes a multiplexing filter 620 and a demultiplexing filter 640 coupled through an amplifier 630 and optical fibers 625 and 626. An advantage provided by a multiplexer/demultiplexer filter module 600 according to the present invention is that a single amplifier 630 can compensate for losses incurred with two or more filters. An SOA amplifier, for example, can have a gain of 12 dB or higher, which is typically sufficient to compensate for the loss due to both filters 620 and 640. For example, a DWDM system that includes a multiplexing AWG and a demultiplexing AWG may require only a single SOA to compensate for both the insertion loss and the polarization dependent loss (PDL) of both the multiplexing and demultiplexing AWG.

Input fibers 610-1 through 610-N carry light signals of different wavelengths. The different wavelengths can correspond to a predetermined wavelength grid, as was discussed above. Optical signals can be coupled into fibers 610-1 through 610-N through connectors 611-1 through 611-N. Multiplexing filter 620 receives the optical signals from each of fibers 610-1 through 610-N and combines the optical signals, producing a single multiplexed signal which is coupled into connecting fiber 625. The multiplexed optical signal from connecting fiber 625 is coupled into amplifier 630, compensates for loss in both multiplexing filter 620 and demultiplexing filter 640. The amplified multiplexed signal is then coupled into optical fiber 626 for transmission to demultiplexing filter 640. Demultiplexing filter 640 demultiplexes the amplified multiplexed signal and couples the components into optical fibers 650-1 through 650-N. Optical signals can be coupled to external fibers (not shown) through connectors 651-1 through 651-N.

In some embodiments of module 600. multiplexing filter 620 and demultiplexing filter 640 can be separated by a significant distance (i.e., several kilometers). Further, in some embodiments of module 600, amplifier 630 may be formed on a single integrated circuit with one of multiplexing filter 620 and demultiplexing filter 640, as is described with FIGS. 3 through 5.

The above-described embodiments of the present invention are merely meant to be illustrative and not limiting. It will thus be obvious to those skilled in the art that various changes and modifications may be made without departing from this invention in its broader aspects. As such, the invention is limited only by the following claims.

We claim:

1. A multiplexer, comprising:
a filter, positioned to receive an optical signal from each of a plurality of optical transmission lines and capable of combining said optical signals into a multiplexed signal;
a semiconductor optical amplifier, positioned to receive said multiplexed signal from said filter and capable of amplifying said multiplexed signal.

2. The multiplexer of claim 1, wherein said filter is an array waveguide grating.

3. The multiplexer of claim 1, wherein said filter is a thin film filter.

4. The multiplexer of claim 1, wherein said filter is a Bragg grating.

5. The multiplexer of claim 1, wherein said filter is a bulk grating device.

6. The multiplexer of claim 1, wherein said filter and said semiconductor optical amplifier are combined on a single integrated circuit chip.

7. The multiplexer of claim 1, wherein said semiconductor optical amplifier substantially compensates for optical losses in the filter.

8. A demultiplexer, comprising:
a semiconductor optical amplifier, positioned to receive a multiplexed signal from a multiplexed signal transmission line and capable of amplifying said multiplexed signal to produce an amplified multiplexed signal; and
a filter, positioned to received said amplified multiplexed signal from said semiconductor optical amplifier and capable of splitting said amplified multiplexed signal into a plurality of optical signals, each of said optical signals having a different wavelength.

9. The demultiplexer of claim 8, wherein said filter is an array waveguide grating.

10. The demultiplexer of claim 8, wherein said filter is a thin film filter.

11. The demultiplexer of claim 8, wherein said filter is a Bragg grating.

12. The demultiplexer of claim 8, wherein said filter is a bulk grating device.

13. The demultiplexer of claim 8, wherein said filter and said amplifier are combined on a single integrated chip.

14. A multiplexer, comprising:
a substrate;
a filter, located on said substrate, capable of receiving a plurality of optical signals and capable of combining said optical signals in a multiplexed signal;
a semiconductor optical amplifier, located on said substrate and positioned to receive said multiplexed signal from said filter, said semiconductor optical amplifier capable of amplifying said multiplexed signal.

15. The multiplexer of claim 14 wherein said substrate is silicon.

16. The multiplexer of claim 14 wherein said substrate is silica glass.

17. A demultiplexer, comprising:
a substrate;
a semiconductor optical amplifier, located on said substrate and positioned to receive a multiplexed signal, said semiconductor optical amplifier capable of amplifying said multiplexed signal to produce an amplified multiplexed signal; and
a filter, located on said substrate, positioned to receive said amplified multiplexed signal, said filter capable of splitting said amplified multiplexed signal into a plurality of optical signals, each of said optical signals comprising a different wavelength.

18. The demultiplexer of claim 17 wherein said substrate is silicon.

19. The demultiplexer of claim 17 wherein said substrate is silica glass.

20. A multiplexer/demultiplexer module, comprising:
a first filter, positioned to receive an optical signal from each of a plurality of optical transmission lines and capable of combining said optical signals in a multiplexed signal;
a semiconductor optical amplifier, positioned to receive said multiplexed signal from said first filter and capable of amplifying said multiplexed signal to produce an amplified multiplexed signal;
a second filter, positioned to received said amplified multiplexed signal from said semiconductor optical amplifier and capable of splitting said amplified multiplexed signal into a plurality of optical signals, each of said optical signals comprising a different wavelength.

21. The module of claim 20, wherein at least one of said first filter and said second filter is an array waveguide grating.

22. The module of claim 20, wherein at least one of said first filter and said second filter is a thin film filter.

23. The module of claim 20, wherein at least one of said first filter and said second filter is a Bragg grating.

26. The module of claim 20, wherein at least one of said first filter and said second filter is a bulk grating device.

27. The module of claim 20, wherein the amplifier is included on a single integrated circuit with at least one of said first filter and said second filter.

28. The module of claim 20, wherein the amplifier substantially compensates for the losses in the first filter and the second filter.

29. A method of multiplexing a plurality of optical signals, said method comprising:
providing a plurality of optical signals;
combining said optical signals to produce a multiplexed signal; and
amplifying said multiplexed signal with a semiconductor optical amplifier.

30. The method of claim 29, wherein combining said optical signals is accomplished with an array waveguide grating.

31. A method of demultiplexing a multiplexed signal, said method comprising:
providing a multiplexed signal;
producing an amplified multiplexed signal by amplifying said multiplexed signal using a semiconductor optical amplifier; and
filtering said amplified multiplexed signal to produce a plurality of optical signals, wherein each of said plurality of said optical signals comprises a different wavelength.

32. The method of claim 31, wherein filtering said amplified multiplexed signal is accomplished with an array waveguide grating.

33. A method of multiplexing and demultiplexing a plurality of optical signals, said method comprising:
providing a plurality of optical signals;
combining said plurality of optical signals to produce a multiplexed signal;
producing an amplified multiplexed signal by amplifying said multiplexed signal with a semiconductor optical amplifier; and
filtering said amplified multiplexed signal to produce a plurality of optical signals, wherein each of said plurality of said optical signals comprises a different wavelength.

34. The method of claim 33, wherein combining said plurality of optical signals is accomplished with an array waveguide grating.

35. The method of claim 33, wherein filtering said amplified multiplexed signal is accomplished with an array waveguide grating.
